(19) United States
(12) Patent Application Publication
(10) Pub. No.: US 2007/0084066 A1
(43) Pub. Date: Apr. 19, 2007

(54) Multi-function power tool

(75) Inventor: James Hastie, Pocklington (GB)

Correspondence Address: MCKEE, VOORHEES & SEASE, P.L.C., 801 GRAND AVENUE, SUITE 3200, DES MOINES, IA, 50309-2721, US

(73) Assignee: GMCA PTY LIMITED, Melbourne Airport (AU)

(21) Appl. No.: 11/228,911

(22) Filed: Sep. 16, 2005

(51) Int. Cl. B27B 9/00

(52) U.S. Cl. 30/391

(57) ABSTRACT

A power tool including a housing for an electric motor and a mounting for a disc having a housing, wherein the motor is arranged to drive the saw blade about its axis. The housing includes at least one guard member covering a peripheral portion of said disc and a debris conduit allowing removal of debris from the disc during use in a first cutting mode. A removable member is attachable to the housing to selectively block the debris conduit such that the tool can be used in a second cutting mode.

### BACKGROUND OF THE INVENTION

The present invention relates to electric power tools and more particularly to tools having a rotating disc which is at least partially enclosed by a guard.

One such conventional power tool is a circular saw, which generally includes a base plate and a circular saw blade mounted relative to the base plate. The saw blade is driven by an electric motor such that when the base plate is rested upon material to be cut, the saw blade extends a distance below the base plate and cuts the material to the required depth.

Conventional tile saws may be either hand-held or bench mounted tools with a circular saw blade driven by an electric motor. Hand-held tile saws show a degree of functional similarity to circular saws in that they require a circular saw blade to be driven by a motor with at least the upper portion of the blade being covered by a fixed guard. In addition each saw requires a suitable handle arrangement to allow a user to guide the saw along a workpiece.

It is generally accepted that, whilst a number of specific power tools have been tailored to meet specific functional requirements of individual tasks, the provision of a combination tool is advantageous since it can avoid the unnecessary expense of owning a number of functionally similar tools.

However a conventional circular saw is unsuitable for use as a tile saw and there are a number of problems involved in combining the functions of a circular saw and a tile saw in a single product. A circular saw is required to have both an upper fixed guard and a lower retractable guard which can be moved to expose the saw blade during use. Furthermore it is advantageous to provide a circular saw with an exhaust and/or extraction means for the removal of debris produced during cutting. In contrast, a tile saw uses a different type of circular blade which is generally required to be lubricated/cooled during operation. Thus the design features of a circular saw tend to inhibit access to the blade for the application of a coolant.

In view of the foregoing problems, it is an object of the present invention to provide a single power tool product which can operate in two cutting modes.

### BRIEF SUMMARY OF THE INVENTION

According to the present invention, there is provided a power tool, said tool including a housing for an electric motor and a mounting for a disc having an axis, said motor arranged to drive the disc about the axis, and said housing including at least one guard member covering a peripheral portion of said disc and a debris conduit allowing removal of debris from the disc during use in a first cutting mode, wherein a removable member is attachable to the housing to selectively block the debris conduit such that the saw can be used in a second cutting mode.

Typically the first cutting mode is for dry cutting and the second mode is a wet cutting mode. In one embodiment, the power tool is a saw with the disc being an associated saw blade. Preferably the debris conduit is for the removal of substantially dry debris, such as sawdust. Typically the debris conduit extends through the guard away from the periphery of the disc so as to direct the debris away from the disc and a user of the power tool. Preferably the removable member can be inserted into the debris conduit so as to block the flow of material therethrough. Thus wet cutting debris can be expelled in a different manner to sawdust.

Typically the removable member may be shaped to fit closely within the debris conduit such that the removable member is held within the recess by a friction fit. The removable member and conduit may be provided with correspondingly shaped to ensure a secure frictional engagement. Friction elements, such as ribs or friction pads, may be provided on either of the recess or the removable member. Additionally or else alternatively, a releasable locking member such as, for example, a latch or catch may be provided to hold the removable member in place.

Preferably a liquid can be selectively provided to the blade. In one embodiment a fluid delivery conduit provides liquid to the disc during operation in a tile cutting mode. Yet more preferably, the fluid delivery conduit is removably attachable to the housing. Additionally or else alternatively, the fluid delivery conduit may be provided with flow control means for adjusting the flow of fluid to the disc. The flow control means may comprise a tap or stopcock.

Thus the power tool can operate in a dry cutting mode or else in a wet mode in which a variable rate of flow can be set for tile cutting applications. The detachable nature of the fluid delivery conduit is particularly advantageous in that the fluid conduit can be removed during dry cutting, preventing the conduit outlet becoming blocked by sawdust.

Preferably the fluid delivery conduit has an outlet through which fluid passes to the disc when attached and typically the fluid delivery conduit is removably attachable to the guard member. According to one embodiment, fluid is delivered to each side of the disc during operation and preferably the fluid delivery conduit has two or more outlets. In this embodiment the fluid delivery conduit may comprise a U-shaped tube.

According to one preferred embodiment, the fluid delivery conduit is attached to the housing by the removable member. The fluid delivery conduit may be integral with the removable member and preferably the removable member is provided with engagement means to hold the fluid conduit in place. The engagement means may comprise any or any combination of grooves, flanges, brackets, bores and/or a clip. Additionally the housing may also be provided with engagement means to hold the fluid conduit in place during wet cutting.

The present invention may be advantageously applied to a handheld circular saw so as to provide a multi-purpose sawing tool. Thus the attachment of the removable member both blocks the debris conduit and provides a fluid delivery conduit to facilitate tile sawing and at the same time inhibit operation of the saw as a standard circular saw. This allows a circular saw to be simply converted for use as a tile saw such that the single saw product can be used in two different modes.

In one embodiment the guard includes fluid delivery formations to direct the fluid onto the blade such that the fluid from the fluid delivery conduit, once attached, is in fluid communication with said delivery formations. The formations may be integral with the guard and may take the form of slots or channels.

Typically the housing includes first and second guard members, the first guard member being fixed relative to the axis of the disc and the second guard member being movable about the disc axis to selectively expose a cutting portion of the disc. Preferably the movable guard member includes apertures therein to allow fluid to be delivered to the disc during use. In one embodiment, the apertures are arranged circumferentially about the disc axis such that the second guard member can be opened to varying degrees without blocking fluid flow to the blade. A guard lock may be provided to hold the second guard member open to a required degree.

Typically the power tool includes a disc release mechanism to allow the disc to be changed. Preferably a trim saw blade and a tile cutting blade are interchangeable to allow the tool to be selectively used for either dry cutting or else tile cutting operations.

According to a further aspect of the present invention there is provided a power tool, said tool including a housing for an electric motor and a disc having an axis, said blade arranged to be driven about the axis by the motor, and said housing including at least one guard member covering a peripheral portion of said disc, wherein a fluid delivery conduit is removably attachable to the housing for selective delivery of fluid to the disc during use.

According to a further aspect of the present invention there is provided a combination power tool, said tool including a housing and a circular saw blade arranged to be driven by a motor such that the saw blade rotates relative to the housing, said power tool having a first configuration wherein the tool functions as a circular saw for dry cutting of a workpiece, and a second configuration wherein a fluid delivery conduit provides fluid to the blade to allow the tool to operate as a tile saw.

### BRIEF DESCRIPTION OF THE DRAWINGS

Specific embodiments of the present invention will now be described in further detail with reference to the companying drawings, in which:

FIG. 1 shows a perspective view of a power tool according to the present invention;

FIG. 2 shows the tool of FIG. 1 with the fluid delivery conduit removed;

FIG. 3 shows an enlarged view of the guard and removable parts in FIG. 2; and,

FIGS. 4a and b show further detail of a movable guard for use with a power tool according to the present invention.

### DETAILED DESCRIPTION OF THE PREFERRED EMBODIMENT

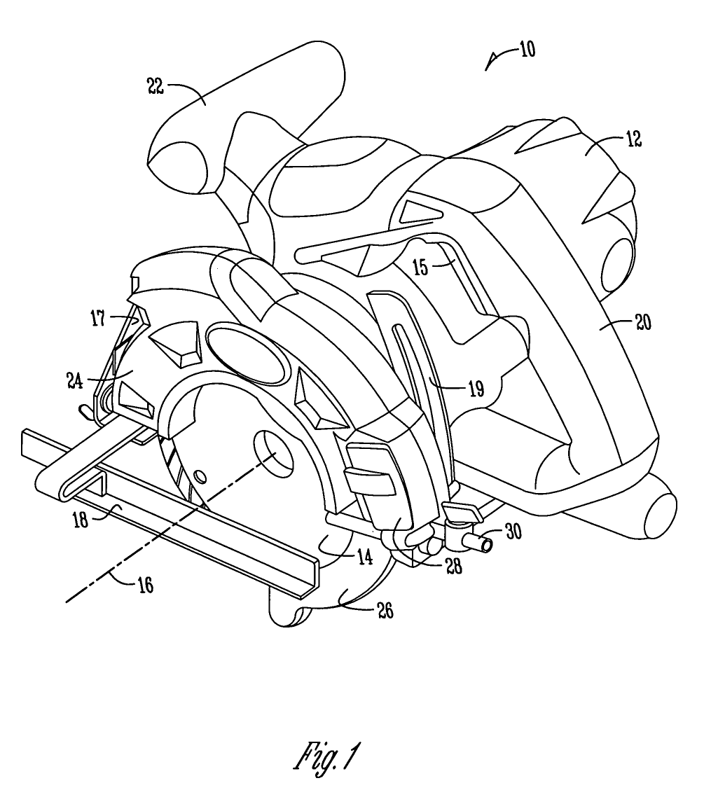

Turning firstly to FIG. 1, there is shown a power tool according to the present invention in the form of a saw, which can be used as a circular saw for dry cutting of a workpiece, or else as a tile saw, wherein fluid is delivered to the saw blade during use.

The saw generally comprises a housing 10 for an electric motor 12 and a disc in the form of circular saw blade 14. The blade 14 is driven by a shaft (not shown) which is connected to the motor 12, such that when the motor is activated by way of on/off switches 15, the blade 14 rotates about the axis 16.

The saw includes an adjustable base plate 18 which contacts a workpiece during use, such that the saw blade 14 is held at the correct orientation relative to the workpiece for cutting. The height and/or angle of the base plate 18 can be adjusted in a conventional manner along guides 17 and 19 and locked in the required position so as to allow cuts to be made to a specific depth and at a required angle. The saw has a main handle 20 and a secondary handle 22 as specified by standards for circular saws such that a user can effectively control the movement of the saw over a workpiece.

A first guard member 24 is fixed over a portion of the saw blade 14 which extends above the base plate 18 and shields the periphery of the saw blade. A cutting section of the saw blade 14 extends below the base plate 18, the periphery of which can be enclosed by a second guard member 26. The second guard member 26 is movable about the axis 16 such that it can extend around the cutting section of the saw blade 14 or else be retracted within the fixed guard member 24 so as to expose the cutting section of the saw blade for use. The second guard member is generally biased towards a closed position and may be provided with a guard lock to hold the guard open during use as a tile saw.

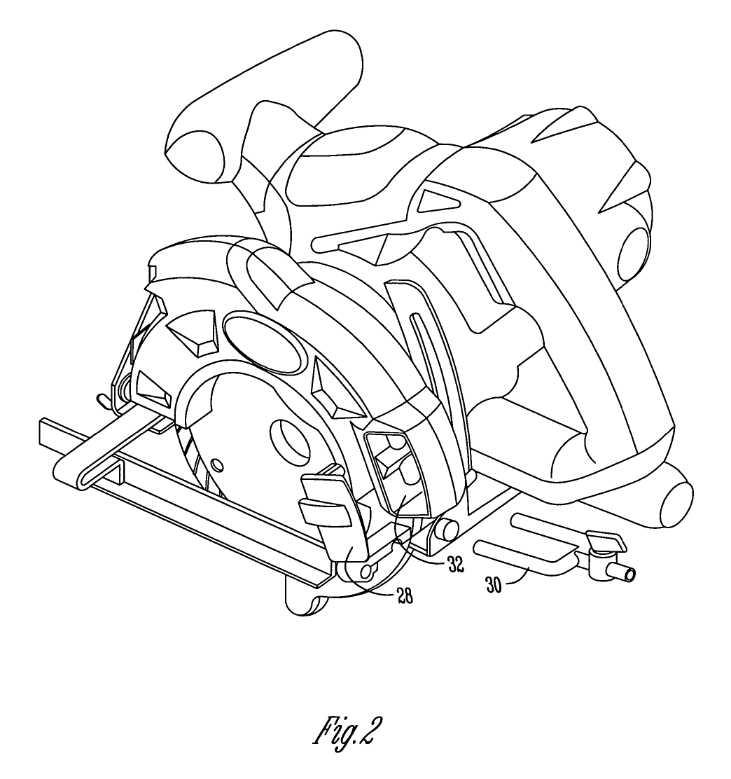

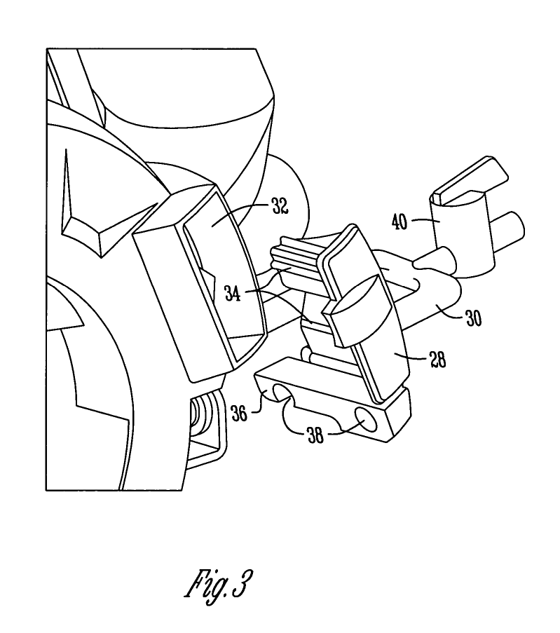

The saw in FIG. 1 is shown ready for use as a tile saw and has a removable member 28 inserted into a recess in the fixed guard 24. As shown in FIG. 2, the recess an outlet portion of debris conduit 32. The removable member 28 includes formations for receiving the fluid delivery conduit 30, the details of which are shown in FIGS. 2 and 3.

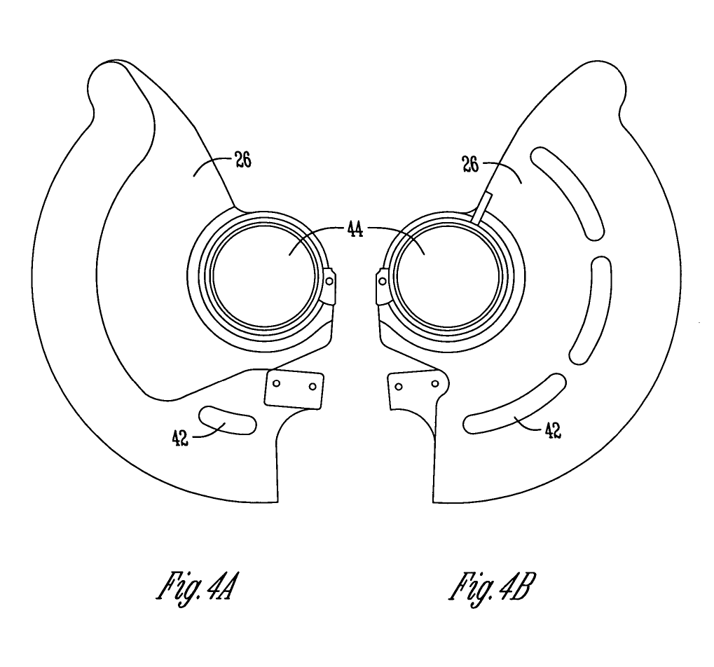

FIG. 2 shows the saw of FIG. 1 ready for use as a circular saw. The removable member 28 and the fluid delivery conduit 30 have been removed such that the debris conduit 32 is exposed within the fixed guard 24. During operation as a circular saw, debris, generally in the form of sawdust, is propelled into the inside of the guards 24 and 26. The movable guard 26 is shaped as shown in FIG. 4 so as to allow the debris to pass into an inlet to the conduit 32. The debris conduit 32 allows the debris to be ejected from the inside of guard member 28 in a particular direction and thus acts as an exhaust.

Blade release means (not shown) are provided to allow a tile saw blade, such as a diamond edged blade, to be interchanged with a circular saw, trim saw, and blade as necessary. The release means may comprise a nut or bolt which is tightened and released by way of an Allen key or spanner, or else may comprise a quick release means, which may allow the manual release of the blade without the need to use a specific tool. Other types of disc may be attached for different applications as necessary, such as for grinding.

Once the correct blade is selected, the saw shown in FIG. 2 can be converted for use as a tile saw by inserting the removable member 28 into the conduit 32 in the direction of arrow A (see FIG. 3) and then clipping the fluid delivery conduit 30 in place. The removable member 28 is shaped to fit the contour of the exhaust port of conduit 32 so as to block the passage of debris therethrough, effectively acting as a plug. As shown in FIG. 3, the removable member 28 includes ribs 34 to ensure a suitable friction fit with the inside surfaces of the conduit 32. In addition a releasable latch or clip may be provided to ensure the removable member remains securely in place.

A portion 36 of removable member 28 extends outside of the conduit and includes formations 38 which are shaped to receive the fluid conduit 30. The removable member thus acts as a mounting member for the fluid conduit. The fluid conduit 30 is a generally U-shaped tube with ends disposed either side of the saw blade 14 when fixed in position. The conduit is fed by a tube and can be attached to any suitable water source as part of a water injection system. In addition the conduit 30 is provided with a tap 40 for controlling the flow of water to the blade from the water source.

Turning now to FIG. 4, each side of the moving guard 26 is shown in further detail and is provided with apertures 42 in order to allow the blade 14 to receive fluid from the fluid delivery conduit 30. The apertures 42 are arranged generally circumferentially about a central opening 44 in the guard 26. The circular opening 44 in the guard 32 allows the guard to be rotably mounted about the saw blade axis. Since the fluid conduit outlets are held in a fixed position relative to the blade axis when attached for tile cutting operations, the movable guard 26 can be provided in various orientations without inhibiting the flow of water to the blade 14 by virtue of the curved apertures 42.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A power tool, said tool including:
a housing for an electric motor and a mounting for a disc having an axis, said motor arranged to drive the disc about the axis, and said housing including at least one guard member covering a peripheral portion of said disc and a debris conduit allowing removal of debris from the disc during use in a first cutting mode, wherein a removable member is attachable to the housing to selectively block the debris conduit such that the power tool can be used in a second cutting mode.

2. A power tool according to claim 1, wherein the debris conduit extends through the guard member away from said disc.

3. A power tool according to claim 1, wherein the removable member is insertable into the debris conduit and is shaped to fit closely within the conduit so as to block the flow of material therethrough during use in said second mode.

4. A power tool according to claim 1, wherein a liquid is selectively provided to the disc by way of a fluid delivery conduit during use in said second mode.

5. A power tool according to claim 4, wherein the fluid delivery conduit is removably attachable to the housing.

6. A power tool according to claim 4, wherein the fluid delivery conduit is provided with flow control means for adjusting the flow of fluid to the disc.

7. A power tool according to claim 4, wherein the fluid delivery conduit is removably attachable to the guard by way of said removable member.

8. A power tool according to claim 4, wherein the fluid delivery conduit is selectively attachable to the removable member by way of engagement formations provided on the conduit and/or the removable member.

9. A power tool according to claim 4, wherein the fluid delivery conduit has two or more outlets, at least one outlet being disposed on each side of the disc during use so as to allow simultaneous delivery of fluid to each side of the disc.

10. A power tool according to claim 1, wherein the housing includes first and second guard members, the first guard member being fixed relative to the axis of the disc and the second guard member being movable about the disc axis to selectively expose a cutting portion of the disc.

11. A power tool according to claim 10, wherein the movable guard member includes apertures through which the fluid can pass to the disc during use.

12. A power tool according to claim 11, wherein said apertures are circumferential in shape.

13. A power tool according to claim 1, further comprising disc release means allowing the removal and/or interchange of discs between use in said first and second cutting modes.

14. A power tool according to claim 11, wherein said disc is a circular saw blade.

15. A power tool, said power tool including:
a housing for an electric motor and a disc having and axis, said disc arranged to be driven about its axis by said motor, and said housing including at least one guard member covering a peripheral portion of said disc, wherein a fluid delivery conduit is removably attachable to the housing for selective delivery of fluid to the disc.

16. A combination power tool, said tool including:
a housing and a circular saw blade arranged to be driven by a motor such that the saw blade rotates relative to the housing, said power tool having a first configuration wherein the tool functions as a circular saw for dry cutting of a workpiece, and a second configuration wherein a fluid delivery conduit provides fluid to the blade to allow the tool to operate as a tile saw.
